(19) United States
(12) Patent Application Publication
(10) Pub. No.: US 2014/0267721 A1
(43) Pub. Date: Sep. 18, 2014

(54) BOW STABILIZER WITH INSERTABLE CAMERA

(71) Applicants: Benjamin Brian Stern, Holmen, WI (US); Randy Hoff, Arcadia, WI (US)

(72) Inventors: Benjamin Brian Stern, Holmen, WI (US); Randy Hoff, Arcadia, WI (US)

(21) Appl. No.: 14/216,360

(22) Filed: Mar. 17, 2014

Related U.S. Application Data
(60) Provisional application No. 61/802,541, filed on Mar. 16, 2013.

(51) Int. Cl. F41B 5/14; H04N 5/225

(52) U.S. Cl. CPC F41B 5/1492; H04N 5/2252; F41B 5/1426
USPC 348/143

(57) ABSTRACT

A bow camera attachment is provided. The bow camera attachment includes a stabilizer camera housing. The camera housing includes a front end and a rear end. The rear end is releasably attachable to a bow. A camera is removably housed within the camera housing. The camera includes a lens positioned near the front end of the camera housing.

### CROSS-REFERENCE TO RELATED APPLICATION

This application claims the benefit of priority of U.S. provisional application No. 61/802,541, filed Mar. 16, 2013, the contents of which are herein incorporated by reference.

### BACKGROUND OF THE INVENTION

The present invention relates to a camera attached to a bow and, more particularly, to a bow stabilizer with an insertable camera.

Bowhunting (or bow hunting) is the practice of hunting game animals by archery. Arrows, bows and sights are the more modern varieties. Currently, it is desirable to video record the hunt. Cameras can be mounted to mounts that add addition weight to the bow beyond the weight added by a common stabilizer. The added weight creates a less accurate shot and produces unwanted torque to the bow when shooting. Other systems of recording the hunt require additional hunters to record the footage.

As can be seen, there is a need for a stabilizer and camera combination that does not add unwanted weight.

### SUMMARY OF THE INVENTION

In one aspect of the present invention, a bow camera attachment comprises: a camera housing comprising a front end, a rear end, a cavity formed within, and an opening formed on a surface of the camera housing leading to the cavity, wherein the rear end is releasably attachable to a bow; and a camera insertable through the opening and removably housed within the cavity of the camera housing, wherein the camera comprises a lens positioned near the front end of the camera housing.

These and other features, aspects and advantages of the present invention will become better understood with reference to the following drawings, description and claims.

### BRIEF DESCRIPTION OF THE DRAWINGS

FIG. 1 is a perspective view of the present invention shown in use;

FIG. 2 is a perspective detail view of the present invention shown in use;

FIG. 3 is a side detail view of the present invention shown in use;

FIG. 4 is an exploded view of the present invention;

FIG. 5 is an exploded view of the present invention;

FIG. 6 is an perspective view of the present invention;

FIG. 7 is a section detail view of the present invention along line 7-7 in FIG. 2;

FIG. 8 is a perspective view of the a stabilizer insert; and

FIG. 9 is a perspective view of the stabilizer insert within the stabilizer camera housing.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a bow stabilizer with a slide in camera. The stabilizer with a removable camera mounts directly onto a bow. The present invention allows the hunter or archer to stay undetected and video wild life while maintaining the ability to shoot the target. Since the camera is mounted in the stabilizer, it does not add any extra weight as compared to a traditional stabilizer and thereby eliminates unwanted torquing.

Referring to FIGS. 1 through 9, the present invention includes a bow camera attachment. The bow camera attachment includes a stabilizer camera housing 10. The camera housing 10 includes a front end and a rear end. The rear end is releasably attachable to a bow 16. A camera 12 is removably housed within the camera housing 10. The camera 12 includes a lens 32 positioned near the front end of the camera housing 10.

In certain embodiments, the camera housing 10 includes an opening at the front end leading to a cavity 24 within the camera housing 10. The opening is formed to receive the camera 12 and the cavity 24 is formed to secure the camera 12. In certain embodiments, a rubber coating 28 covering an inside surface forming the cavity 24. The rubber coating 28 may line the inside surface of the cavity 24 and may thereby prevent damage to the camera 12.

The camera housing 10 may be in the form of a tubular shape similar to a standard stabilizer. The camera 12 may also be in the form of a tubular shape and may fit within a tubular cavity 24 of the housing 10. The camera 12 may further include an interchangeable lens 32 for changing the views of the camera 12.

The camera housing 10 may be secured to the bow 10 similar to a standard stabilizer. The camera housing 10 may include a threaded post 18 protruding from the rear end. The bow 16 may include a female threaded receiver 26 formed to receive and secure the threaded post 26 and thereby secure the camera housing 10 to the bow 16. In certain embodiments, the present invention may further include a rubber dampener 30 secured around the threaded post 18 adding flexibility and thereby preventing damage to the bow 16 and the camera housing 10.

In certain embodiments, the camera housing 10 may include a plurality of openings through the surface of the camera housing 10 leading into the cavity 24. In certain embodiments the camera housing 10 may include a set screw protrusion 40 having a threaded opening 22 through the camera housing 10 leading to the cavity 24. The threaded opening 22 is formed to receive a set screw 14 for securing the camera 12 within the cavity 24. Therefore, a user may place the camera 12 within the camera housing 10 and screw the set screw 14 within the threaded opening 22 to make contact with the camera 12 and secure the camera 12 within the camera housing 10.

The camera housing 10 of the present invention may further include a slot 20 formed in the camera housing 10 and leading to the cavity 24. The slot 20 may align with a camera button 38 on the camera 12. A longitudinal slot 42 may also be formed at the opening and leading to the slot 20. The longitudinal slot 42 may guide the user when inserting the camera 12 and may prevent the camera housing 10 from interfering with the button 38. The camera 12 may include a plurality of buttons 38, such as a record button and a stop button. Due to the slot 20 of the housing 10, the user may access the buttons 38 while the camera 12 is within the housing 10. Therefore, when the user sees a game, the user may easily press the accessible button 38 to record.

In certain embodiments, the camera housing 10 may also include an audio port 34 formed in the camera housing 10 leading to the cavity 24. The audio port 34 may align with a microphone 44 on the camera 12. Therefore, the user may place the camera 12 within the camera housing 10 so that the microphone 44 is aligned with the audio port 34 and may thereby also record sound.

The present invention may further include a stabilizer insert 36. The stabilizer insert 36 is interchangeable with the camera 12. Therefore, the camera 12 may be removed, and the stabilizer insert 36 may be secured within the cavity 24 of the camera housing 10. Both the camera 12 and the stabilizer insert 36 may include a weight added to the camera housing 10 to match a weight of a standard stabilizer.

A method of using the present invention may include the following. A user may insert the camera into the camera housing and tighten the set screw so that the camera is properly secured within the camera housing. The user may then mount the stabilizer to the bow. The user may then press the record button and record the hunt and the game. To view the video, the camera slides out of the stabilizer and can be connected to a computer to access the video files.

It should be understood, of course, that the foregoing relates to exemplary embodiments of the invention and that modifications may be made without departing from the spirit and scope of the invention as set forth in the following claims.

What is claimed is:

1. A bow camera attachment comprising:
a camera housing comprising a front end, a rear end, a cavity formed within the camera housing, and an opening formed on a surface of the camera housing leading to the cavity, wherein the rear end is releasably attachable to a bow; and
a camera insertable through the opening and removably housed within the cavity of the camera housing, wherein the camera comprises a lens positioned near the front end of the camera housing.

2. The bow camera attachment of claim 1, wherein the opening is formed at the front end leading to the cavity within the camera housing.

3. The bow camera attachment of claim 1, further comprising a threaded opening through the camera housing leading to the cavity, wherein the threaded opening is formed to receive a set screw for securing the camera within the cavity.

4. The bow camera attachment of claim 1, wherein a slot is formed in the camera housing leading to the cavity, wherein the slot aligns with a camera button on the camera.

5. The bow camera attachment of claim 1, wherein an audio port is formed in the camera housing leading to the cavity, wherein the audio port aligns with a microphone on the camera.

6. The bow camera of claim 1, further comprising a rubber coating covering an inside surface forming the cavity.

7. The bow camera of claim 1, wherein the rear end comprises a threaded post formed to mate with a female threaded receiver of the bow.

8. The bow camera if claim 7, further comprising a rubber dampener secured around the threaded post.

9. The bow camera of claim 1, wherein the camera comprises an interchangeable lens.

10. The bow camera of claim 1, further comprising a stabilizer insert interchangeable with the camera within the camera housing, wherein the stabilizer insert comprises a weight added to the camera housing to match a weight of a standard stabilizer.
